(19) United States
(12) Patent Application Publication
(10) Pub. No.: US 2008/0029123 A1
(43) Pub. Date: Feb. 7, 2008

(54) SONIC AND CHEMICAL WAFER PROCESSOR

(76) Inventors: Brian Aegerter, Kalispell, MT (US); Nolan L. Zimmerman, Kalispell, MT (US); Chris Lee Gentry, Kalispell, MT (US); Kyle M. Hanson, Kalispell, MT (US)

Correspondence Address: PERKINS COIE LLP/SEMITOOL, PO BOX 1208, SEATTLE, WA, 98111-1208, US

(21) Appl. No.: 11/461,938

(22) Filed: Aug. 2, 2006

(51) Int. Cl. B08B 3/12; B08B 7/00; B08B 3/00

(52) U.S. Cl. 134/1; 134/33; 134/137; 134/184; 134/198; 134/34

(57) ABSTRACT

A workpiece processor has a process chamber for holding a liquid. A sonic element, such as a megasonic transducer, is positioned to provide sonic energy into the liquid. A workpiece holder is moveable from a first position, wherein a workpiece is held immersed in the liquid, for sonic processing, to a second position where the workpiece is generally aligned with spray nozzles. Process liquids and gases may be sprayed or otherwise provided onto the workpiece, optionally while the workpiece is rotating within the process chamber. A process chamber gas or vapor exhaust assembly prevents escape of process gases or vapors from the processor. The processor can provide both sonic processing, as well as liquid and/or gas chemical processing.

### BACKGROUND

Sonic energy is used to expedite and improve processing of semiconductor wafers and similar substrates. Typically, the wafer is immersed in a bath of liquid. Sonic energy is then introduced into the liquid from one or more megasonic or ultrasonic transducers. This sonic processing may reduce the amount of process chemicals needed and also provide more uniform and efficient processing. Other liquid or gas phase chemical processing steps often precede or follow sonic processing.

In many applications, the chemical processing steps use a gas, such as ozone, which must be contained. As sonic processing machines may generally not be designed to contain or use gases or vapors, the wafer must be moved to another machine for gas phase processing. This can require additional time, additional risk of wafer contamination or damage via the added handling and movement. It also requires an additional machine to perform the gas phase processing. Accordingly, improved machines and methods are needed for processing wafers and similar substrates using sonic energy before, during, or after processing with a gas.

### SUMMARY

A new wafer processor which can provide both sonic and chemical processing, including gas phase chemical processing, has now been invented. As a result, a wafer may now be both sonically cleaned or processed, and also chemically cleaned or processed, using gas or liquid phase process chemicals, in a single process chamber. Manufacturing of devices from wafers can accordingly be performed more efficiently and more quickly. In one form, this new wafer processor may include a sonic element, such as a megasonic transducer, positioned to provide sonic energy into a liquid contained in a process chamber. The processor may include a head having a wafer holder, with the head moveable to place the wafer holder into lower and upper positions in the process chamber. In the lower position, a wafer supported by the wafer holder may be immersed in a liquid for sonic processing. In the upper position, the wafer may be chemically processed via gas or liquid phase process chemicals. A seal may be provided between the processing chamber and the head, to contain and/or control movement of process chemicals within the processor. Other features and advantages will be apparent from the following description and drawings. The drawings are provided for explanation, and should not be viewed as providing limits on the scope of the invention. The invention resides as well in subcombinations of the elements and steps described.

### BRIEF DESCRIPTION OF THE DRAWINGS

In the drawings, wherein the same reference number indicates the same element in each of the views:

FIG. 1 is a section view of a novel wafer processor, showing the wafer in a raised position, for processing using one or more gases or liquids.

FIG. 2 is a section view of the processor shown in FIG. 1, with the wafer immersed in a bath of liquid for sonic processing.

FIG. 3 is an alternative section view of the processor shown in FIGS. 1 and 2.

FIG. 4 is a perspective view of the base of the processor shown in FIGS. 1-3.

FIG. 5 is a plan view of the base shown in FIG. 4.

FIG. 6 is a section view taken along line 6-6 of FIG. 5.

FIG. 7 is a section view taken along line 7-7 of FIG. 5.

FIG. 8 is a section view taken along line 8-8 of FIG. 5.

FIG. 9 is a plan view of an alternative motor for use in the processors shown in FIGS. 1-3.

FIG. 10 is a section view taken along line 10-10 of FIG. 9.

FIG. 11 is an enlarged view of the labyrinth seal shown in FIG. 10.

FIG. 12 is an inverted perspective view of the lower plate shown in FIG. 10.

FIG. 13 is a perspective view of the upper plate shown in FIG. 10.

FIG. 14 is a perspective view of an automated processing system which may be used with the processor shown in FIGS. 1-8.

FIG. 15 is a perspective view of internal components of the automated processing system shown in FIG. 14.

### DESCRIPTION OF THE DRAWINGS

### I. Overview

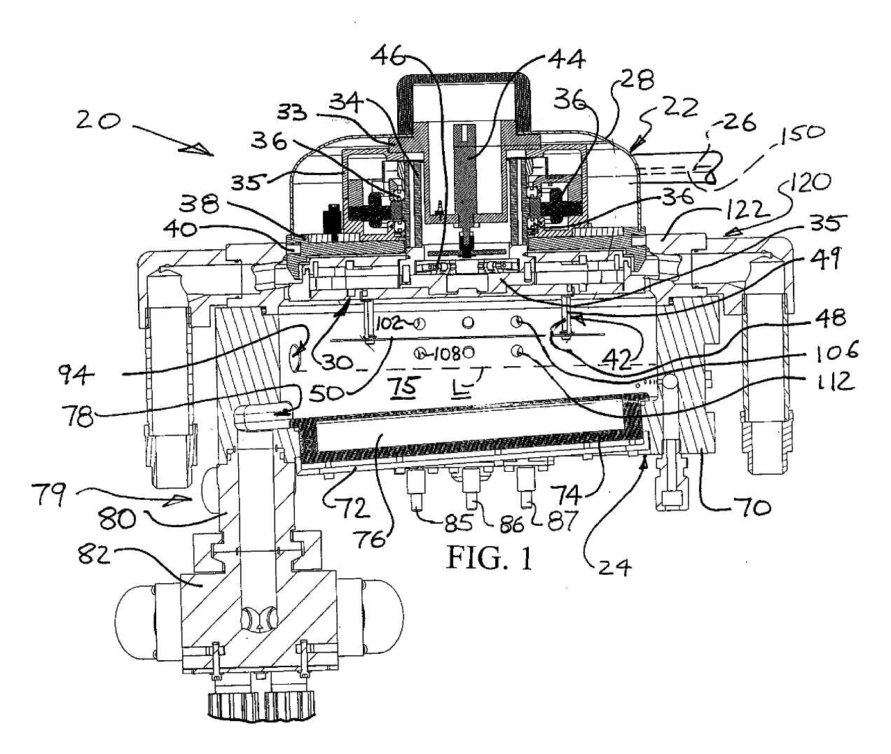

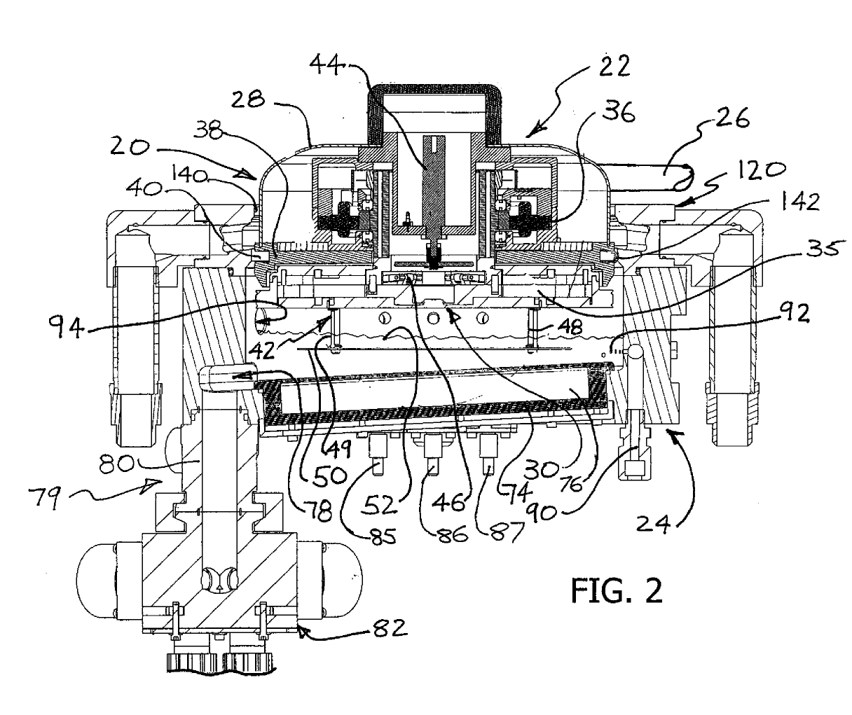

As shown in FIGS. 1-3, a processor 20 has a process chamber 75 which may be partially filled with a liquid. A sonic element 76 is associated with the process chamber 75, to provide sonic energy into a bath of liquid in the process chamber 75. The sonic element 76 may be a megasonic or ultrasonic transducer. The processor 20 also includes a wafer holder assembly 42 for moving a wafer 50 vertically within the process chamber 75. FIG. 2 shows the wafer holder assembly 42 holding the wafer 50 in a first position. In the first position, the wafer 50 is submerged in a bath of liquid 52. The sonic element 76, in this case positioned at the bottom of the bath of liquid 52, introduces sonic energy which passes through the liquid 52 to the wafer 50, to sonically process the wafer 50.

The wafer holder assembly 42 may also move the wafer 50 into a second position which is shown in FIG. 1. In the second position, the wafer 50 is above the level L of the liquid, or the liquid may be removed from the process chamber. While in the second position, the wafer 50 may be processed using one or more gases introduced into the process chamber 75. While in the second position, the wafer 50 may also be processed using one or more process liquids sprayed or otherwise applied onto the wafer 50, optionally while the wafer holder assembly 42 rotates the wafer 50. One or more process gases may be provided in the process chamber 75 during this spray processing. The processor 20 also has a gas or vapor exhaust assembly 120 which helps to contain process gases within the processor 20.

### II. Terms

The term wafer or workpiece includes semiconductor wafers, flat panel displays, rigid disk or optical media, thin film heads or other workpieces formed from a substrate on which microelectronic circuits, data storage elements or layers, or micro-mechanical or micro-optical elements may be formed. The term gas here includes vapors as well. The term spray processing here includes processing by spraying, flowing, jetting, or otherwise applying one or more liquids onto a wafer. The term sonic processing here includes processing or cleaning by providing sonic energy, such as ultrasonic or megasonic energy, to a wafer at least partially immersed in, or covered by, a liquid. The term gas phase processing includes a wafer with a process gas, with gas provided as a dry gas alone, or mixed with a gas, or with gas provided entrained or dissolved in a liquid. Singular expressions used here include the plural, and vice versa.

### III. Detailed Description

The wafer holder assembly 42 and the process chamber 75 may have various designs. In the design shown in FIGS. 1-3, the wafer holder assembly 42 is part of a head 22 which can be raised and lowered vertically, relative to the process chamber 75, by a head lifter 26. A motor 32 is supported on a head plate 38. A head housing on the head plate 38 covers the motor 32. A rotor sleeve 34 is supported on bearings 36 within the motor 32. The rotor sleeve 34 is part of a rotor assembly 30 which can rotate relative to the head 22. The rotor assembly 30 includes the rotor sleeve 34, a rotor plate 35 attached to the rotor sleeve 34, and the wafer holder assembly 42 which is attached to the rotor plate 35. The specific wafer holder assembly 42 shown in the drawings includes fingers 48 which hold the wafer 50 at the edges. An actuator 44 is supported on an actuator holder 33 on the motor housing 35 and does not spin. Stand off pins 49 support the wafer from below during wafer loading and unloading, when the head is inverted. When the rotor is stationary, the fingers 48 may be moved radially outwardly to load and unload a wafer, via movement of the actuator 44 acting on a linkage 46 connected to the fingers 48.

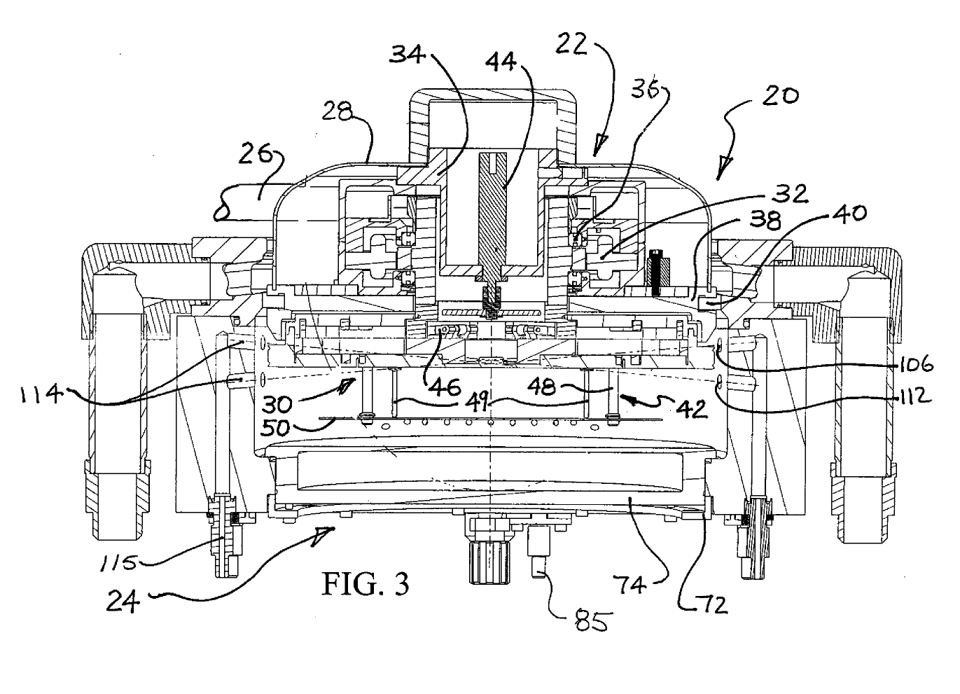

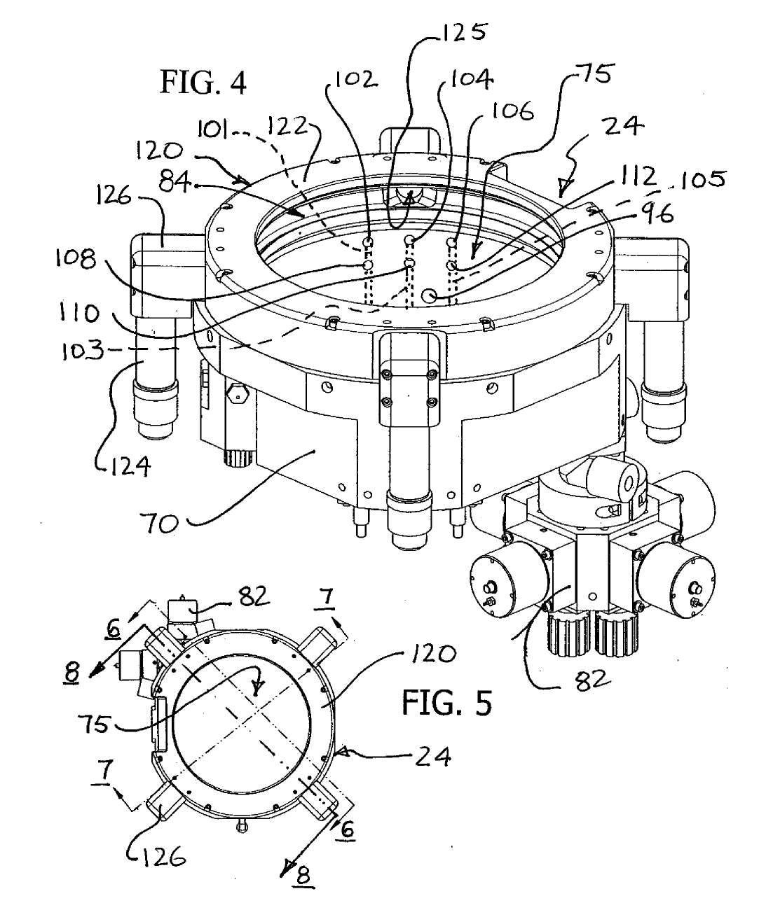

The process chamber 75 may have various different designs. In the design shown in FIGS. 1-3, the process chamber 75 is formed by a base 24 including a gas exhaust assembly 120 on top of a bowl 70. Referring momentarily to FIG. 4, the process chamber 75 formed in the base 24 has an open top 84. Referring to FIGS. 1-4, the sonic element or transducer 76 is contained within a plate housing 74, which largely forms the bottom surface or floor of the process chamber 75. The plate housing 74 is sealed against the bowl 70, so that the process chamber 75 can hold liquid. A bottom clamp ring 72 helps to secure the plate housing 74 in place on the bowl 70.

As shown in FIGS. 1 and 2, a bowl drain 78 leads from the process chamber 75 to a drain valve 82 attached to a lower end of the bowl 70 by an adapter 80. The valve 82 is shown as a four-way valve, that is the valve 82 can be operated to direct liquid flowing out of the bowl drain 78 into one of four separate liquid lines, for re-use, storage, treatment, or e.g., release into a facility drain. The valve 82 may also simply be closed to prevent flow out through the bowl drain 78. The valve 82 may be a 2, 3, 4, 5, 6, or higher way valve, depending on the number and type of process liquids to be used in the processor 20.

Referring to FIG. 4, the bowl 70 may have multiple pairs of spray nozzles. In the design shown in FIG. 4, six pairs of process liquid nozzles or outlets are provided. Three pairs are visible in FIG. 4, with the other three pairs on the opposite side of the bowl not visible in FIG. 4. The first pair includes nozzles 102 and 108, the second pair includes nozzles 104 and 1 10, and the third pair includes nozzles 106 and 112. Each pair of nozzles may be connected to a separate process liquid supply line, shown in dotted lines in FIG. 4 as supply lines 101, 103, and 105.

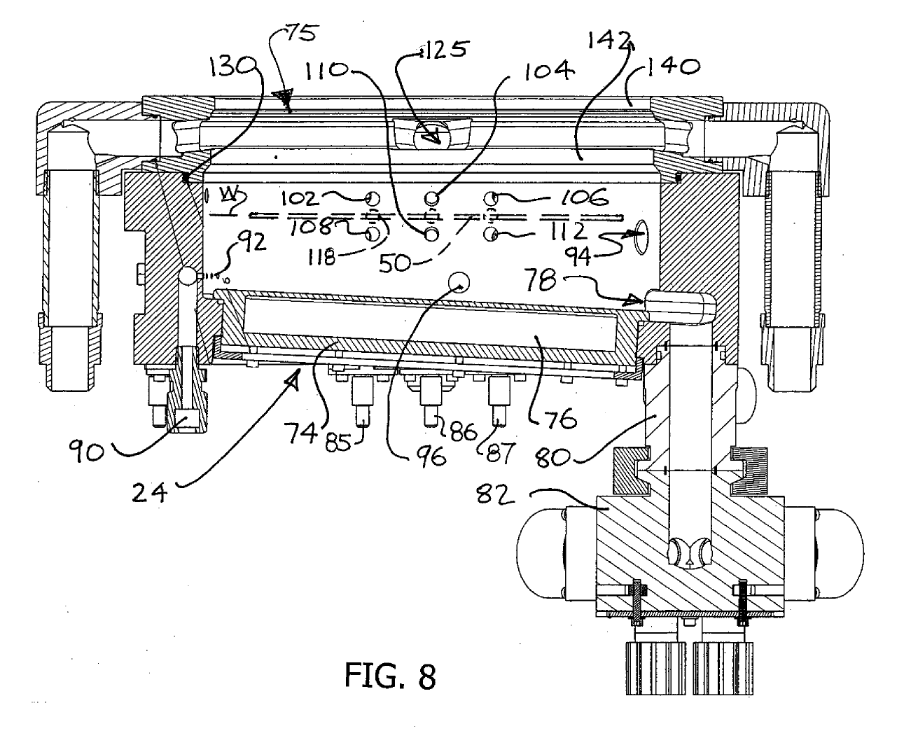

Referring momentarily to FIGS. 1 and 8, with the wafer 50 in the second or raised position, the upper nozzles 102, 104, and 106, of each pair may be positioned to spray onto the top surface of the wafer 50, while the lower nozzle of each pair, 108, 110, and 112, may be positioned to spray onto the lower surface of the wafer 50. Referring to FIG. 8, in addition to, or in place of, any of the process liquid nozzles, edge-on nozzles 118 may also be provided in the bowl 70. The edge-on nozzles 118, if used, are aligned with the wafer 50 and generally spray radially inwardly in a straight direction, at the edge of the wafer 50. While the edge-on nozzles 118 are shown aligned with pairs of process liquid nozzles, they may also be offset from them. In addition, the arrangement or pattern of all of the nozzles shown may of course be varied.

Referring to FIGS. 1, 2, and 8, one or more spillway openings 94 are provided through the cylindrical sidewalls of the bowl 70. The position of the spillway opening 94 determines the maximum level L of the liquid bath in the process chamber 75. Liquid is supplied into the process chamber 75 through a liquid supply line 90 connecting to bowl inlets 92 near the bottom of the bowl, as shown in FIG. 8. Accordingly, the bowl 70 is filled with process liquid from the bottom up, with the liquid level rising until it reaches the spillway opening 94. As shown in FIGS. 4 and 8, a liquid level sensor 96 is provided near the bottom of the bowl 70. The liquid level sensor 96 is electrically connected to a processor controller, such as the controller 260 described below. The controller prevents operation of the sonic transducer 76 unless the liquid level sensor 96 senses liquid in the bowl 70.

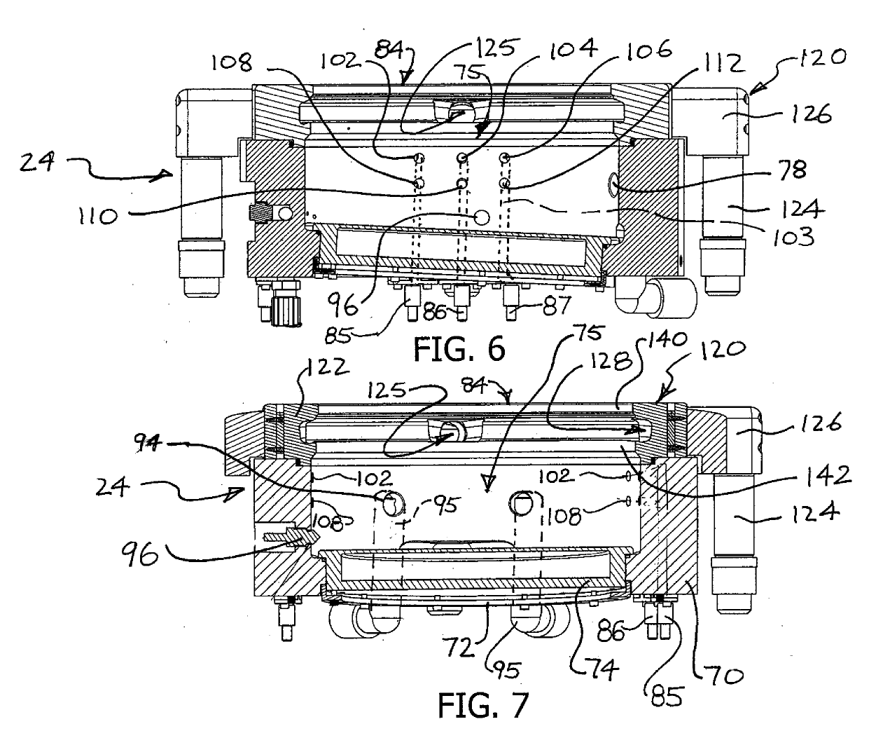

Referring to FIGS. 4-8, an exhaust assembly 120 is provided on a top surface of the bowl 70. The exhaust assembly 120 may include an annular exhaust ring 122 generally concentric with the bowl 70. Exhaust outlets 125 may extend radially outwardly through the exhaust ring 122. In the design shown, four exhaust outlets 125 are provided, although 1, 2, 3, 4 or more exhaust outlets 125 may be used. An annular exhaust groove 128 can be provided on an inner surface of the exhaust ring 122, with the exhaust outlets 125 opening into the exhaust groove 128, as shown in FIGS. 4 and 6-8. An exhaust elbow 126 may be attached to the exhaust ring 122 at each exhaust outlet 125, with a tube 124 connecting to each exhaust elbow 126. The tubes 124 may generally be connected to a system or facility exhaust, which may include a vacuum source, for drawing gases out of the process chamber 75. As shown in FIG. 8, a rim seal 130 may be provided to better seal the exhaust ring 122 onto the bowl 70. As shown in FIGS. 7 and 8, the exhaust ring 122 may include an annular upper seal surface 140 and a lower seal surface 142, with the exhaust groove 128 between the seal surfaces 140 and 142. The seal surfaces 140 and 142 are typically spaced apart by about 2, 3 or 4 cm. Referring to FIG. 1, a head seal 40 on the head 22 may be sealed against the upper seal surface 140. As shown in FIG. 2, the head seal 40 may also seal against the lower seal surface 142.

### IV. Representative Examples of Methods

In use, the processor 20 can perform sonic processing with a wafer immersed in a bath of liquid in the process chamber 75. The processor 20 may also perform chemical processing, rinsing, and/or drying within the process chamber 75. In a typical use, a wafer 50 is loaded into the wafer holder assembly 42. The head 22 may be inverted and lifted vertically up and away from the base 24, for wafer loading and unloading. Operation of the processor 20, generally including loading and unloading, is generally controlled by an electronic controller or computer, such as the controller 260 described below. While various designs of the head 22, and various loading methods may of course be used, the head 22 shown in FIGS. 1 and 2 is loaded with the head 22 in an inverted position, as described in U.S. Patent Publication No. US2005/0199066 A1, incorporated herein by reference. The actuator 44 drives the linkage 46 causing the fingers 48 to move slightly radially outwardly. A wafer 50 is then placed onto the standoff pins 49, with the wafer between the fingers 48, typically via robot. The robot (if used) is withdrawn. The actuator 44 then reverses movement, causing the fingers 48 to grip the edges of the wafer 50. The head 22 is rotated typically ½ turn and is lowered onto the base 24 by the head lifter 26 or the lift/rotate unit 270 described below.

For sonic processing, the head 22 is moved into the position shown in FIG. 2. The head seal 40, which may be an inflatable seal, contacts the lower seal surface 142, substantially closing off and sealing the open top of the process chamber 75. Alternatively, the head seal 40 may remain spaced apart from the seal surface 142, or it may remain un-inflated, during sonic processing, if no ozone or other toxic gas is being used. In this case, the exhaust assembly 120 can remove vapors moving out of the process chamber 75. A process liquid is provided into the bowl 70 via the liquid supply line 90 and bowl inlets 92. The bowl 70 fills with liquid from the bottom up. The liquid level rises until it reaches the level L of the spillway opening 94 as shown in FIG. 1. As shown in FIG. 2, the wafer 50 is then entirely covered by the liquid. The controller detects the presence of sufficient liquid 52 in the bowl 70 via a signal provided from the liquid level sensor 96. The controller then energizes the sonic transducer 76. Sonic energy from the transducer 76 moves through the plate housing 74 and through the liquid 52 to the wafer 50. The sonic energy imparted to the wafer 50 results in acoustic cavitation helping in particle removal. While the drawings show a bath of liquid 52, the liquid may also be provided as a thin film or layer between the wafer and the sonic element, such as the plate housing 74 of the sonic transducer 76.

The motor 36 in the head 22 may optionally slowly rotate the wafer 50 during this sonic processing. Alternatively, the wafer 50 may be stationary. The frequency, intensity, and duration of the sonic energy provided may vary. Ultrasonic processing typically ranges from 20-350 kHz, with megasonic frequencies generally ranging from 700-3000 or 5000 kHz. Typically, in the design shown in the drawings, megasonic frequencies are used. As shown in FIGS. 1 and 2, the transducer 76 and plate housing 74 may be positioned on an angle relative to horizontal (i.e., the surface of the liquid 52) and to the plane of the wafer 50, to reduce reflections of sonic energy.

Referring still to FIG. 2, during sonic processing, a continuous flow of liquid may optionally be provided into the process chamber 75 through the inlets 92, with liquid at the surface simultaneously continuously draining out of the process chamber 75 through one or more spillway openings 94 or through the drain 78. This optional step helps to maintain a constantly refreshed bath of liquid 52 within the process chamber 75. The liquid 52 may be deionized water, with or without additives, including process chemicals and/or dissolved or entrained gases. The process liquid 52 may optionally be heated by a liquid heater before the liquid 52 is provided into the bowl 70. Liquid flowing out through the spillway opening 94 is removed from the bowl 70 through spillway drains 95, shown in FIG. 7. The space above the liquid may be filled with air, or another gas, typically at ambient pressure, although pressures above or below ambient may also be used.

Referring still to FIG. 2, after sonic processing is complete, the controller turns off the sonic transducer 76. The valve 82 may then be operated to drain the liquid 52 out of the bowl 70 through the bowl drain 78. The drained liquid may be conveyed to a storage location to be held for re-use, or for treatment. Alternatively, depending on the composition of the liquid 52, it may be drained out through the valve 82 to a facility drain. The processing chamber 75 may then optionally be rinsed by providing a rinse liquid into the chamber 75, via inlets 92 and/or one or more of the spray nozzles.

The processor 20 may also process the wafer 50, using gas or liquid process chemicals either before or after sonic processing. Referring now to FIG. 1, to perform gas or liquid chemical processing, the head 22 is raised by the head lifter 26, from the position shown in FIG. 2 to the position shown in FIG. 1. As shown in FIGS. 1 and 8, with the head 22 in the second position, the wafer 50 is positioned between the upper spray nozzles 102, 104, and 106, and the lower spray nozzles 108, 110, and 112. The wafer 50 is also aligned with any edge-on nozzles 118, if used. Referring to FIG. 1, the seal 40 seals the head plate 38 of the head 22 against the upper seal surface 140 of the exhaust ring 122. Process liquids or gases are provided to the spray nozzles through liquid or gas inlet fittings 85, 86, and 87, shown in FIG. 1.

The specific liquids and gases provided to the spray nozzles may vary. For example, in the design shown in FIG. 1, deionized water may be provided to inlets 85 and 87, and sprayed onto the wafer 50 by nozzles 102 and 108, and nozzles 106 and 112. Ozone gas may be provided to the inlet 86 and be sprayed, or otherwise released from nozzles 104 and 110. The process chamber 75 may be substantially filled with ozone gas, to perform an ozone gas/heated liquid process, as described, for example, in U.S. Pat. No. 6,869,487, incorporated herein by reference. Typically, the liquid 52 used in the sonic processing is removed from the bowl 70 before spray processing, although this is not necessary. Removing the liquid 52 before gas or liquid chemical processing reduces or avoids any mixing of the liquid 52 with process chemicals. This allows the liquid 52 to more easily be re-used or disposed of.

During gas or liquid chemical processing, the controller may continuously or intermittently turn on the motor 32, causing the rotor assembly 30 to spin the wafer 50. Spinning the wafer 50 may help to distribute process liquids sprayed onto the wafer from the spray nozzles. Spin sequences, speeds, duration, etc. may be controlled by the controller, and may vary with the specific processes performed.

Referring to FIG. 1, with the head 22 in the second position as shown in FIG. 1, gases in the process chamber 75 are sealed within the processor 20 by the seal 40. However, due to the need for clearance between the rotor assembly 30 and other components of the head 22, gases may potentially move from the processing chamber 75 into the head 22. This may cause damage to the head 22, as some process gases are highly corrosive. In addition, unless the head 22 itself is sealed, gases could also potentially leak out of the process chamber 75 through the head 22.

To prevent gases from entering the head 22, the head may be continuously pressurized with a purge gas, such as nitrogen. The head purge gas, if used, may be supplied to the head 22 through a purge gas line in the head lifter 26, as shown in FIG. 1. In addition, gases may be continuously drawn out of the process chamber 75 through the exhaust assembly 120. With negative pressure applied to the tubes 124, gases may be continuously drawn out of the processor 20 through the exhaust outlets 125 in the exhaust ring 122, through the tubes 124, and to a system or facility gas exhaust line. Referring to FIG. 3, during or after spray processing, a rinse liquid, such as deionized water, may be sprayed at the rotor assembly 30 from rotor spray nozzles 102, 104, 106, 108, 110, and/or 112. The rotor assembly 30 may accordingly be less subject to corrosion or oxidation by process liquids or gases. While the nozzles shown in the drawings are fixed in place, movable nozzles may also be used, to sweep or aim a spray or stream of liquid or gas at or across specific locations in the chamber 75. The nozzles, whether fixed or moveable, may provide a stream, cone, fan, or other pattern.

Referring to FIG. 3, the bowl 70 may also include rinse nozzles 114 connected to a rinse liquid supply line 115. The rinse nozzles 114, if used, may be directed to spray a liquid, such as deionized water, onto the rotor assembly 30, when the wafer 50 is in the first and/or second position. Rinse nozzles 114 may also optionally be oriented to spray a rinse liquid onto the wafer itself.

### V. Alternative Head Motor

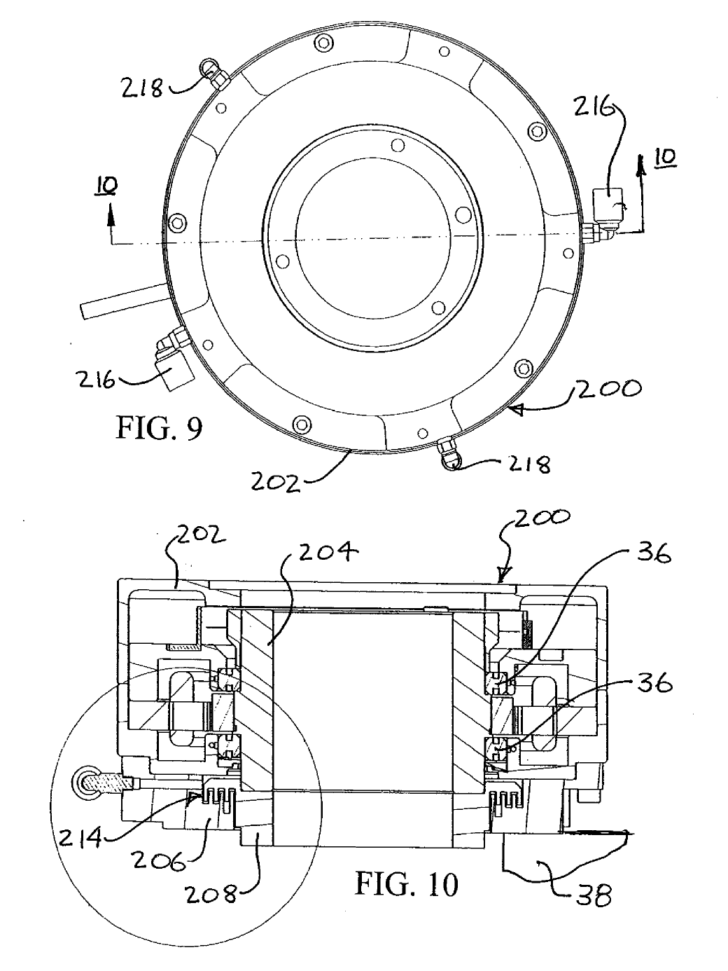

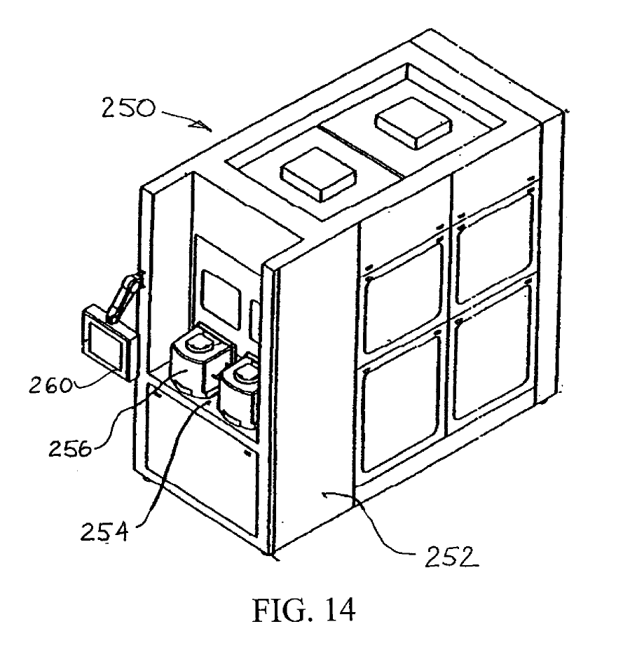

Turning to FIGS. 9-13, an alternative embodiment motor 200 may be used in place of the motor 32 shown in FIGS. 1-3. As shown in FIG. 10, the motor 200 has a shaft or cylinder 204 supported on bearings 36 within a housing 202. A lower plate 206 is supported directly or indirectly on the head plate 38, and does not rotate. An upper plate 208 is attached to, or part of, the cylinder 204, and rotates with the cylinder 204.

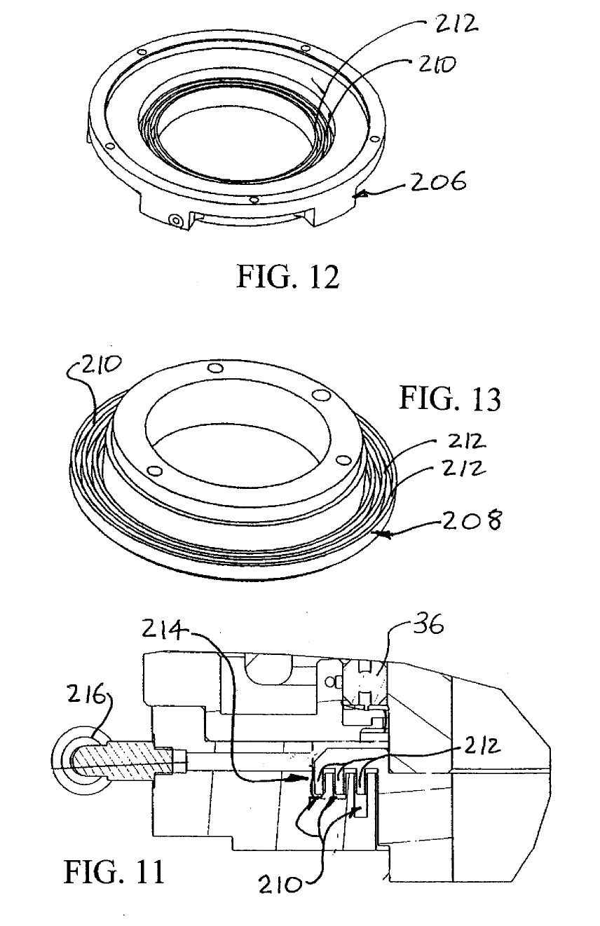

As best shown in FIG. 11, the lower plate 206 and the upper plate 208 each have ridges 212 extending into corresponding grooves 210, to form a labyrinth seal 214. Nominal clearance is provided between the ridges 212 and grooves 210, so that they do not touch, as the upper plate 208 rotates relative to the lower plate 206. In the design shown in FIGS. 10-13, three ridges 212 positioned within three corresponding grooves 210 are used, although 1, 2, 3, 4, 5 or more grooves and ridges may be used.

Referring to FIG. 9, one or more aspiration lines 216 or gas purge lines 218 may be provided in the motor 200. By controlling gas pressure and flow characteristics around the labyrinth seal 214, movement of process gases or liquids into the motor can be reduced or avoided. In addition, the labyrinth seal 214 reduces potential for movement of particles created within the motor 200 into the process chamber 75. This reduces potential for contamination of a wafer in the process chamber 75. The labyrinth seal 214 also helps to capture and hold droplets of liquid which may move from the rotor assembly 30 into the seal 214 when the head 22 is inverted for loading or unloading.

Referring to FIG. 11, with aspiration applied to the seal 214, any particles generated within the motor 200, for example from the bearings 36, and moving downwardly towards the labyrinth seal 214, will tend to be drawn out of the motor 200 by the aspiration line 216 and/or be trapped in the labyrinth seal 214. Correspondingly, any gases which pass through the seal 214 will tend to be drawn off via the aspiration line 216. A similar effect, in the reverse direction, may be achieved via the purge line 218. Referring to FIGS. 10 and 11, with purge gas supplied to the labyrinth seal 214, any particles generated within the motor 200 will tend to be carried upwardly, away from the labyrinth seal 214 and the process chamber 75, via the flow of purge gas into the motor 200. Similarly, the purge gas will tend to inhibit movement of process chemicals or vapors through the labyrinth seal 214 and into the motor 200.

### VI. Representative Example of an Automated System

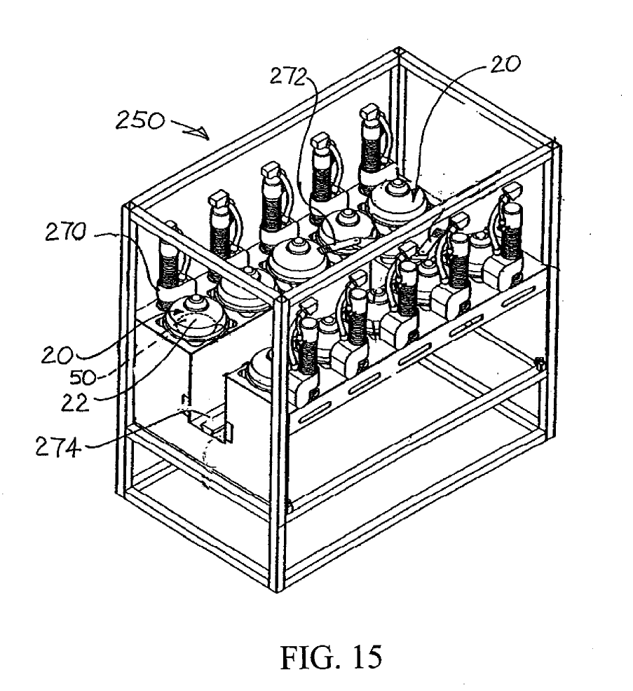

Referring to FIGS. 14 and 15, an array of processors 20 may be provided in an automated processing system 250. A typical automated processing system 250, as shown in FIG. 14, has an enclosure 252, and an input/output station 254, for moving wafers into and out of the enclosure 252. The wafers may be provided to the system 250 in cassettes or boxes 256. A controller 260 may be provided to control various functions of the system 250, as well as the processors 20 contained within the system 250.

Referring to FIG. 15, in the design shown, two straight columns of processors are shown. One or more of these may be a processor 20 as shown in FIGS. 1-8. A lift/rotate mechanism 270 may be associated with a processor 20, to lift and rotate a processor head (such as the head 22 and head lifter 26 described above) for wafer loading and unloading. A robot 272 may be provided within the system 250 for moving wafers from the input/output station 254 to one or more processors, or for moving a wafer from one processor to another processor. In the design shown in FIG. 15, the robot 272 moves linearly along a path or track 274. The processors may of course be arranged in other configurations, such as in an arc, circle, etc., and with a robot performing all needed wafer movement using articulated or extending arms or end effectors without any translational movement of the robot. Operation of the automated processing system 250 is described in U.S. Patent Application Publication US2005/0199066 A1.

Various changes and substitutions may of course be made without departing from the spirit and scope of the invention. The invention, therefore, should not be limited, except by the following claims and their equivalents.

1. A workpiece processor comprising:
a process chamber;
a sonic element positioned to provide sonic energy into a liquid contained in the process chamber;
at least one liquid inlet and at least one liquid drain in the process chamber;
at least one process gas inlet in the process chamber;
a head including a workpiece holder, with the head moveable to place the workpiece holder into first and second positions, with the second position above the first position; and
a seal on at least one of the head and the process chamber, for forming a seal between them, when the workpiece holder is in the first position and in the second position.

2. The workpiece processor of claim 1 further comprising:
a process chamber exhaust assembly attached to an upper end of the process chamber, with the seal on the head and with the process chamber exhaust assembly having first and second seal surfaces for forming a seal with the head, when the workpiece holder is in the first and second positions, respectively.

3. The workpiece processor of claim 1 further including a rotor on the head and with the workpiece holder supported on the rotor;
a spin motor linked to the rotor; and
a head lifter attached to the head, with the workpiece holder moveable from the first position to the second position by operating the head lifter to lift the head.

4. The workpiece processor of claim 2 with the process chamber having an open top and with the process chamber gas exhaust assembly substantially surrounding the open top of the process chamber.

5. The workpiece processor of claim 1 further comprising a plurality of process liquid chemical spray nozzles in the process chamber oriented to spray a liquid process chemical towards the second position.

6. The workpiece processor of claim 1 further comprising:
a head plate in the head;
a motor on the head plate;
a sleeve rotatably supported in the motor;
a motor seal between the head plate and the sleeve.

7. The workpiece processor of claim 6 further comprising one or more aspiration lines connecting with the motor seal.

8. A workpiece processor comprising:
a base including a bowl for holding a liquid;
a sonic transducer in the bowl;
one or more liquid inlets and outlets in the bowl;
one or more gas inlets in the bowl;
one or more liquid spray nozzles in the bowl;
a gas exhaust assembly on the base;
a head including a rotor;
a workpiece holder on the rotor; with the head moveable to position the workpiece holder to a first position in the base, and to a second position in the base, with the second position above the first position.

9. The processor of claim 8 with the gas exhaust assembly having spaced apart first and second seal rings, and with the head having a seal engageable against the first seal ring, when the head is in a first position, and against the second seal ring when the head is in a second position.

10. The processor of claim 8 with the gas exhaust assembly including an exhaust ring attached to a top surface of the base.

11. The processor of claim 9 with the gas exhaust assembly having an annular exhaust groove between the first and second seal rings, and a plurality of spaced apart gas exhaust outlets leading out from the exhaust groove.

12. The processor of claim 8 with the liquid spray nozzles including a plurality of process chemical spray nozzles, and with each process chemical spray nozzle connected to one or more liquid process chemical supply lines, and with substantially all of the process chemical spray nozzles positioned to spray a process chemical towards a workpiece in the workpiece holder, when the workpiece holder is in the second position.

13. The processor of claim 8 further comprising a drain line connected to the liquid outlets, and a valve having an inlet connected to the drain line and with the valve having a plurality of outlets, and with the valve switchable to connect any one of the drain outlets with the drain inlet.

14. The processor of claim 8 wherein the first position is below the liquid outlets and the second position is above the liquid outlets.

15. The processor of claim 8 further comprising an ozone gas source connected to one or more of the gas inlets.

16. A method for processing a workpiece comprising:
immersing the workpiece in a bath of a first liquid in a process chamber;
providing sonic energy into the bath of the first liquid;
removing the workpiece from the bath of the first liquid;
providing a process gas into the process chamber;
rotating the workpiece;
spraying the workpiece with a second liquid;
exhausting the process gas from the process chamber by drawing the process gas through a plurality of gas exhaust outlets adjacent to a top end of the process chamber.

17. The method of claim 16 further comprising rotating the workpiece while the workpiece is immersed in the bath of liquid.

18. The method of claim 16 further comprising removing the first liquid from the process chamber to a first liquid storage location, before spraying the second liquid.

19. A workpiece processor comprising:
a process chamber;
sonic processing means for providing sonic energy to a workpiece immersed in a bath of liquid in the process chamber;
workpiece moving means for moving the workpiece out of the bath of liquid and for rotating the workpiece;
spray process means for applying process chemical liquids onto the workpiece while the workpiece is rotating within the process chamber, and after the workpiece is moved out of the bath of liquid;
process gas means for providing a process gas into the process chamber; and
process gas exhaust means for preventing release of process gas from the process chamber.

20. The workpiece processor of claim 19 wherein the process gas exhaust means comprises an exhaust ring on top of the process chamber, with the exhaust ring including multiple spaced apart gas outlets for drawing process gas out of the process chamber.
